(19) United States
(12) Patent Application Publication
(10) Pub. No.: US 2021/0285066 A1
(43) Pub. Date: Sep. 16, 2021

(54) SYSTEM AND METHOD FOR CONTROLLING THE DEGREE BRIX IN AN AQUEOUS SOLUTION SUCH AS MAPLE SYRUP

(71) Applicant: DOMINION & GRIMM INC., Ville d'Anjou (CA)

(72) Inventor: Jocelyn LARIVIÈRE, St-Prosper (CA)

(21) Appl. No.: 17/196,410

(22) Filed: Mar. 9, 2021

Related U.S. Application Data
(60) Provisional application No. 62/987,590, filed on Mar. 10, 2020.

(51) Int. Cl. C13B 25/04; A23L 27/10; A23L 5/20; B01D 1/00; B01D 1/30

(52) U.S. Cl. CPC C13B 25/04; A23L 27/10; A23V 2002/00; B01D 1/0082; B01D 1/30; A23L 5/21

(57) ABSTRACT

The system and method allow to automatically control the degree Brix of an aqueous solution at a processing plant outlet. The processing plant includes an evaporator for boiling the aqueous solution to increase its degree Brix. The method comprises setting a threshold value of a first parameter of the aqueous solution, monitoring the first parameter of the aqueous solution within an evaporator with a first parameter sensor, and sending monitored first parameter values to a computer or to a valve controller. Then, when a monitored value of the first parameter becomes at least equal to the threshold value of the first parameter of the aqueous solution, controlling the valve controller to allow aqueous solution to flow out of the evaporator towards the processing plant outlet. The method also comprises setting a first threshold value of a second parameter of the aqueous solution at the computer, the second parameter being related to the degree Brix of the solution, monitoring the second parameter of the aqueous solution at the processing plant outlet with a second parameter sensor, and sending monitored second parameter values to the computer and, when a monitored value of the second parameter becomes at least equal to the first threshold value of the second parameter of the aqueous solution, the computer sending a command to at least one of the heater of the evaporator and the valve controller to adjust the level of evaporation of the aqueous solution.

### CROSS REFERENCE DATA

This patent application claims convention priority based upon co-pending U.S. provisional patent application Ser. No. 62/987,590 filed Mar. 10, 2020.

### BACKGROUND OF THE INVENTION

Maple syrup is made from the sap of sugar maple trees. In cold climates, these trees store starch in their trunks and roots before winter; the starch is then converted to sugar that rises in the sap in early spring with warming weather. In commercial operations, maple trees are tapped by transversely drilling holes into their trunks and collecting the sap usually with elongated flexible vacuum tubing systems running from the trees to a processing plant known as a sugarhouse. There, the maple sap is processed by heating inside evaporator pans, to evaporate much of the water, leaving a concentrated maple syrup at the outlet of the evaporator pans.

In open pan evaporation, from 20 to 50 volumes of maple sap is collected and boiled down at temperatures of preferably 4 degrees Celsius over the boiling point of water, to obtain one corresponding volume of maple syrup, without chemical agents or preservatives. Maple sap has between approximately 1.5 to 3.5 percent sugar density, which is variable and will fluctuate even with the same tree. A typical maple tree can produce from 20 to 60 litres of maple sap per season.

Maple syrups are graded according to maple syrup scales based on their density and translucency. Standards classification have been set under the Canadian Food inspection agency and United States department of Agriculture, whereby maple syrup must be at least 66% maple sap sucrose (66 degrees Brix or °Bx), and are designated as follows:
1. Golden grade, with delicate taste;
2. Amber grade, with rich taste;
3. Dark grade, with robust taste; and
4. Very dark grade, with strong taste.

The dark and very dark grade are used mainly for cooking and baking, while the golden and amber grade maple syrup constitutes an exquisitely tasteful drinking solution that is very popular to consumers.

Meeting maple syrup government standards allows a commercial producer to access retail distribution at grocery stores and the like at much better sales price margins. Having maple syrup concentration below 66°Bx will tend to allow degradation of the maple syrup so that the latter will spoil quickly, since the sugar inside the syrup acts as a food preserver in addition to its taste and nutritional values. Degree Brix concentrations above this threshold will not bring additional taste value to the maple syrup, thus reducing the producer's profit margin because any excess sugar concentration is at the expense of producer's operating costs since it takes heating energy and care in preparation of maple syrup. Moreover, syrup boiled too long will crystallise. Accordingly, sap is a perishable product, and it must be processed in a timely manner after release from the tree to minimize the health hazard of microbial contamination and the taste alteration in maple syrup quality.

Maple syrup manufacturing process further involves filtering sterilization to minimize microbial contamination. Indeed, when extracted from the tree trunk, the sap is colourless, flavourless and high in bacterial content.

More particularly, a commercial maple syrup evaporator allows the sap to follow a continuous path from the maple sap inlet through the pan sections, then out of the evaporator and to a maple syrup draw-off tank. Heat is applied under the entire surface of an evaporator pan until the sap reaches a slightly lower density than that of finished product, and is processed to final density in a separate finishing pan. Further evaporated syrup is then filtered to be of clear product, through a pressure filter. The maple syrup is finally stored in barrels, before retail packaging.

Degree Brix (°Bx), referred to above, is the unit that represents the sugar content in the liquid-state maple syrup or, more generally, of sucrose within an aqueous solution. It represents more particularly the percentage in mass of sucrose within the liquid solution. The °Bx unit is used as a unit to quantify the percentage in mass of sugar in maple syrup but also in wine, carbonated beverages, fruit juices, honey and other similar products.

The °Bx can be measured with a few different devices. One such device is the hydrometer: this device will measure the relative density of the maple syrup. The relative density refers more specifically to the ratio of the density of the maple syrup to the density of water, at 20° C. The temperature is relevant since density varies according to the temperature of the aqueous solution. The relative density of syrup being greater than that of water, the higher the °Bx of the syrup, the higher its relative density will be.

Maple syrup is produced through an evaporator pan that will be heated underneath by a heater. To allow the measurement of the °Bx while the syrup is still hot, it is possible to use a hydrotherm. A hydrotherm combines a hydrometer and a thermometer, such that it is possible to cross reference the relative density of the maple solution inside the evaporator pan with the temperature thereof, to obtain the corresponding °Bx at a predetermined temperature standard level, e.g. 20° C.

An alternate °Bx maple syrup measuring tool can be the refractometer. This refractometer device measures the index of optical refraction in the aqueous solution, by which can be correlated the sugar density in the maple syrup. By referring to tables that cross-reference the refractive index of syrup to the °Bx, at a given temperature, the optical properties of the sample of syrup being measured will yield the °Bx of that sample.

### SUMMARY OF THE INVENTION

The invention relates to a method of automatically controlling the degree Brix of an aqueous solution at a processing plant outlet of a processing plant of the type comprising:
an evaporator comprising a heater for bringing the aqueous solution inside the evaporator at a temperature higher than the boiling point of the aqueous solution such that its degree Brix will increase during evaporation;
an evaporator outlet for allowing aqueous solution flow out of the evaporator;
an evaporator outlet valve at the evaporator outlet for controlling the flow of the aqueous solution through the evaporator outlet;
a valve controller that controls the evaporator outlet valve; and
a computer linked to at least one of said heater and said valve controller;
with the processing plant outlet being located downstream of the evaporator outlet, the method comprising the following steps:
   a. setting a threshold value of a first parameter of the aqueous solution at at least one of said computer and said valve controller, the first parameter being related to the degree Brix of the solution;
   b. monitoring the first parameter of the aqueous solution within the evaporator with a first parameter sensor, and sending monitored first parameter values to the at least one of said computer and said valve controller;
   c. when a monitored value of the first parameter becomes at least equal to said threshold value of said first parameter of the aqueous solution, controlling the valve controller to allow aqueous solution to flow out of the evaporator towards the processing plant outlet;
   d. setting a first threshold value of a second parameter of the aqueous solution at said computer, the second parameter being related to the degree Brix of the solution;
   e. monitoring the second parameter of the aqueous solution at the processing plant outlet with a second parameter sensor, and sending monitored second parameter values to the computer;
   f. when a monitored value of the second parameter becomes at least equal to said first threshold value of said second parameter of the aqueous solution, said computer sending a command to at least one of said heater and said valve controller to adjust the level of evaporation of the aqueous solution.

In one embodiment, said computer is linked to said evaporator heater, said method comprising the step of said computer sending a command to at least one of said evaporator heater and said valve controller to adjust the level of evaporation of the aqueous solution in step (f).

In one embodiment, the method of automatically controlling the degree Brix of an aqueous solution further comprises the steps of:
g. monitoring a third parameter of the aqueous solution within the evaporator with a third parameter sensor, and sending monitored third parameter values to the computer, the third parameter being related to the degree Brix of the solution;
h. correlating, at said computer, at least one of the first and third monitored parameter values with the monitored second parameter values, to generate an estimated degree Brix at said processing plant outlet, wherein the step of said computer sending a command to at least one of said evaporator and said valve controller to adjust the level of evaporation of the aqueous solution comprising adjusting the level of evaporation with respect to the estimate degree Brix to obtain a target degree Brix of said aqueous solution at said processing plant outlet.

In one embodiment, the step of sending a command from the computer to at least one of said valve controller and said evaporator to adjust the evaporation level of the aqueous solution within the evaporator in step (f) comprises at least one of controlling the valve controller to open or close the evaporator outlet valve, and controlling the evaporator heater to increase or decrease the heat dispensed by the evaporator to the aqueous solution therein.

In one embodiment, the first parameter is the temperature of the aqueous solution in the evaporator.

In one embodiment, the second parameter is the degree Brix of the aqueous solution at the processing plant outlet.

In one embodiment, the third parameter is the degree Brix of the aqueous solution in the evaporator.

In one embodiment, step (e) is accomplished in real time.

In one embodiment, steps (e), (g) and (h) are accomplished in real time.

In one embodiment, step (e) is accomplished at discrete time intervals.

In one embodiment, steps (e), (g) and (h) are accomplished at discrete time intervals.

In one embodiment, said processing plant outlet is located within a tank and said processing plant comprising a water source, a water outlet allowing water to flow from said water source into said tank, a water outlet valve for controlling the flow of water through the water outlet, and a water outlet valve controller linked to said computer and that controls the water outlet valve, and wherein in step (f) when a monitored value of the second parameter becomes at least equal to said second threshold value of said second parameter of the aqueous solution, said computer sending a command to said water outlet valve controller to inject water in said tank to adjust the °Bx of the aqueous solution.

In one embodiment, said processing plant further comprises a filtering unit between said evaporator outlet and said processing plant outlet, with the aqueous solution flowing from evaporator outlet to said processing plant outlet flowing through said filtering unit.

In one embodiment, said monitoring of the degree Brix at said processing plant outlet and at said evaporator is performed by means of a selected one of a hydrotherm and a refractometer.

In one embodiment, the method of automatically controlling the degree Brix of an aqueous solution further comprises the following steps:
a. setting a second threshold value of said second parameter of the aqueous solution at said computer, such that the first and second threshold values define a range of values of said second parameter of the aqueous solution;
b. at step (f), when a monitored value of the second parameter is outside said range of values of said second parameter of the aqueous solution, said computer sending a command to said valve controller to adjust the level of evaporation of the aqueous solution.

In one embodiment, said range of values of said second parameter of said aqueous solution is a degree Brix range between 66° and 67°.

The present invention also relates to a processing plant for an aqueous solution comprising:
an evaporator comprising a heater for bringing the aqueous solution inside the evaporator at a temperature higher than the boiling point of the aqueous solution such that its degree Brix will increase during evaporation;
an evaporator outlet for allowing aqueous solution flow out of the evaporator;
an evaporator outlet valve at the evaporator outlet for controlling the flow of the aqueous solution through the evaporator outlet;
a valve controller that controls the evaporator outlet valve;
a computer linked to at least one of said heater and said valve controller;
a processing plant outlet being downstream of the evaporator outlet;
wherein the computer comprises a computer readable medium storing a computer program that, when executed by a processor of the computer, allows the following:
   a. setting a threshold value of a first parameter of the aqueous solution at at least one of said computer and said valve controller, the first parameter being related to the degree Brix of the solution;
   b. monitoring the first parameter of the aqueous solution within the evaporator with a first parameter sensor, and sending monitored first parameter values to the at least one of said computer and said valve controller;
   c. when a monitored value of the first parameter becomes at least equal to said threshold value of said first parameter of the aqueous solution, controlling the valve controller to allow aqueous solution to flow out of the evaporator towards the processing plant outlet;
   d. setting a first threshold value of a second parameter of the aqueous solution at said computer, the second parameter being related to the degree Brix of the solution;
   e. monitoring the second parameter of the aqueous solution at the processing plant outlet with a second parameter sensor, and sending monitored second parameter values to the computer;
   f. when a monitored value of the second parameter becomes at least equal to said first threshold value of said second parameter of the aqueous solution, said computer sending a command to said at least one of said heater and said valve controller to adjust the level of evaporation of the aqueous solution.

In one embodiment, said processing plant outlet is located within a tank, said processing plant further comprising a water source, a water outlet allowing water to flow from said water source into said tank, a water outlet valve for controlling the flow of water through the water outlet, and a water outlet valve controller linked to said computer and that controls the water outlet valve, and wherein when a monitored value of the second parameter becomes at least equal to said second threshold value of said second parameter of the aqueous solution, said computer sending a command to said water outlet valve controller to inject water in said tank to adjust the °Bx of the aqueous solution.

In one embodiment, the processing plant for an aqueous solution further comprises a filtering unit between said evaporator outlet and said processing plant outlet, with the aqueous solution flowing from said evaporator outlet to said processing plant outlet flowing through said filtering unit.

In one embodiment, said second parameter is the degree Brix, said processing plant comprising a selected one of a hydrotherm and a refractometer to measure the degree Brix at said processing plant outlet.

### BRIEF DESCRIPTION OF THE DRAWINGS

FIG. 1 is a prior art system diagram showing maple syrup collection by evaporation from upstream maple sap to downstream maple syrup, and suggesting how the degree brix can be manually monitored with a hydrometer, with the outlet portion of the evaporator being shown enlarged in the encircled line;

FIG. 2 is a system diagram of the maple syrup processing plant and method of operation, for real time control of the degree brix in an aqueous solution such as maple syrup according to the present invention, with the outlet portion of the evaporator being shown enlarged in the encircled line;

FIG. 3 is an enlarged elevational view of the Brix controller unit from FIG. 2; and

FIG. 4 is an enlarged elevational view of the thermally insulated maple syrup sampling tank of FIG. 2.

### DETAILED DESCRIPTION OF THE EMBODIMENT OF THE INVENTION

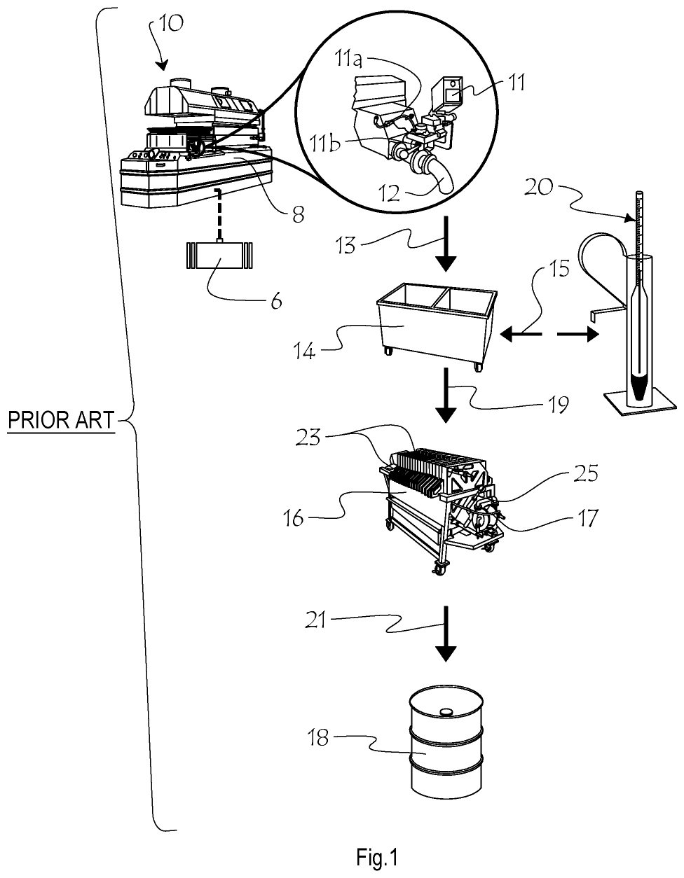

FIG. 1 shows a diagram of a prior art maple syrup processing system and method for producing maple syrup, and suggests how to manually measure its °Bx with a hydrometer. The maple sap that has been collected from trees is conveyed into the evaporator unit 10 by a tubing system (not shown) where it is evaporated inside one or more evaporator pans 8 by a heater 6 mounted underneath the evaporator pan 8. A valve controller 11 controls by means of a valve 11b the flow of maple syrup solution from the outlet spout 12 of the evaporator pan 8 into a draw-off tank 14 via a first fluid outlet line 13. Tank 14 may be rollably mounted over ground. Intermittent degree Brix validation of the maple syrup solution in draw-off tank 14 is performed manually by an operator with a hydrotherm 20 via a second fluid line 15. From draw-off tank 14 the maple syrup solution will be conveyed through a syrup filter press unit 16 under bias from a circulator fluid pump 17 sucking the maple syrup solution from draw-off tank 14 via a third fluid line 19. Fluid pump 17 will bias the maple syrup solution through filtering membranes 23 mounted onto the rigid frame 25 of the filter press unit 16, before exiting therefrom at fourth fluid line 21. Purified end product maple syrup is then allowed to travel through a fourth fluid line 21 into storage barrels 18. Barrels 18 are then shipped to retail outlets for consumption.

Valve controller 11 comprises a thermostat linked to a temperature measuring device 11a for measuring the temperature of the maple syrup solution within the enclosure of pan 8 from evaporator 10, near valve 11b. Valve controller 11 allows setting a threshold flow temperature value that is the temperature in the evaporator pan at which the valve 11b will be triggered to open by valve controller 11 to allow the syrup to flow out through outlet spout 12 into draw-off tank 14. An initial threshold flow temperature value may be selected by the operator according to their knowledge of the approximate temperature that is required to be reached to obtain approximately the right °Bx concentration, for example at about 4° Celsius above the boiling point for the syrup, such as 104° C. When this maple solution temperature in the evaporator pan is reached, the maple syrup starts flowing out downwardly into draw-off tank 14 through spout 12. The user will then collect a sample of syrup in draw-off tank 14 and manually measure the °Bx for example with a hand-held hydrotherm 20.

Depending on several factors including the temperature of the sap being fed to the evaporator, the time of season (that influences the sap composition), the quantity of liquid solution in the evaporator, and many others, the °Bx may and usually will vary even if a same temperature set point is programmed at valve controller 11. To obtain the °Bx of the maple syrup in tank 14 at a desired value, measurements are manually consequently performed at intermittent time intervals with hydrotherm 20 by periodic samplings from draw-off tank 14 and then measuring the °Bx concentration thereof.

This prior art process for measuring the °Bx is inefficient and time-consuming since it requires manual human intervention to monitor and measure the °Bx maple solution concentration at regular time intervals. Furthermore, there is an unavoidable delay between the measurement of the °Bx of a sample, and the manual adjustment of the actual °Bx in the maple syrup downstream end batch being produced: by the time the maple syrup sample is retrieved, cooled and measured, the evaporator pan, intermediate the upstream and downstream ends of the evaporator system, has continued to evaporate the maple syrup solution during that delay and the °Bx has changed already, so that Brix parameter value measured has also changed during this delay, wherein this Brix value is not the sugar concentration in real time because of this delay.

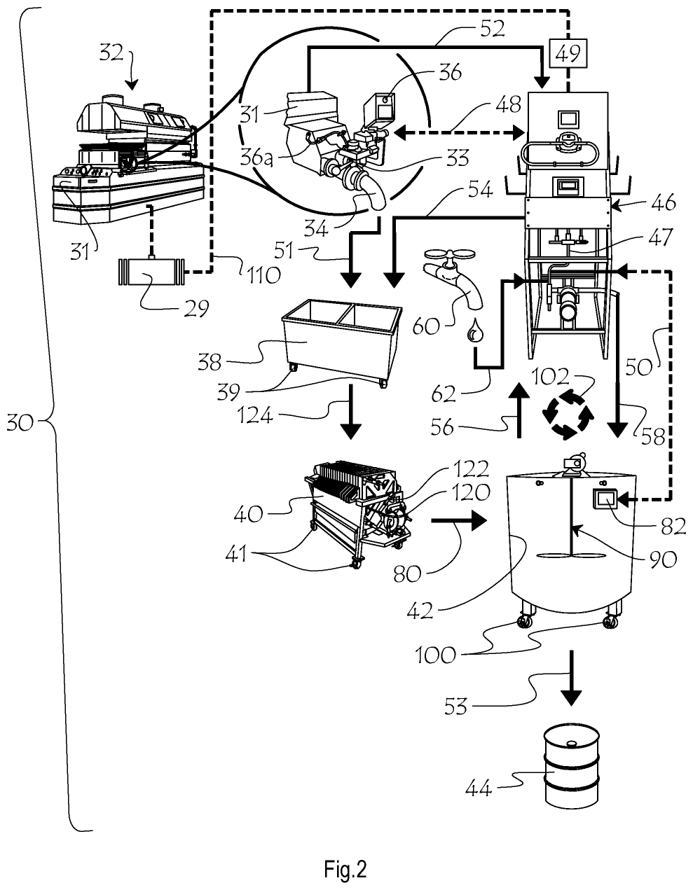

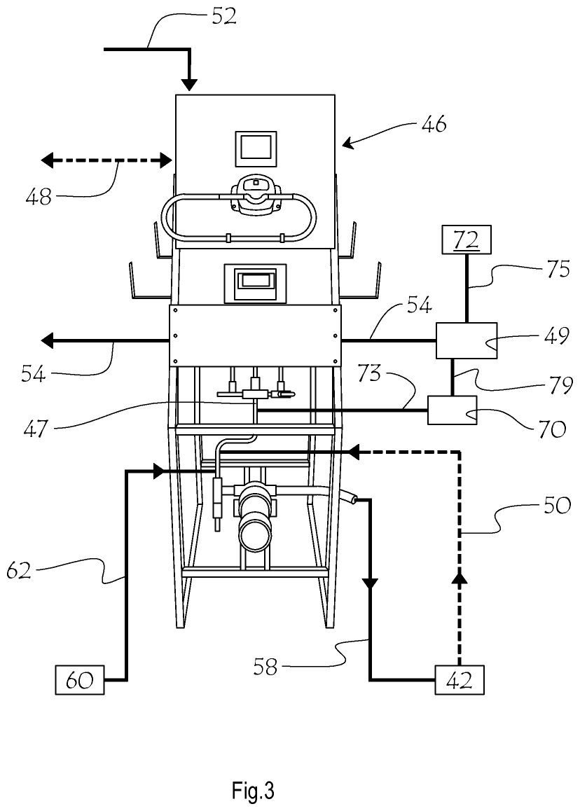

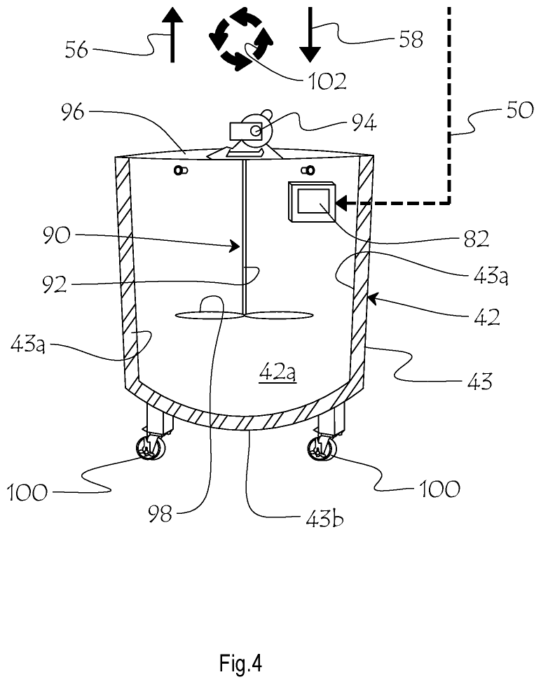

FIGS. 2, 3 and 4 show one embodiment of a maple syrup processing plant 30 and method thereof to control the °Bx in an aqueous solution such as maple syrup, according to the present invention.

Processing plant 30, normally provided in a sugarhouse, comprises an evaporator unit 32 wherein maple sap is conveyed and evaporated by a heater 29 mounted underneath one or more evaporator pans 31 to produce maple syrup. Evaporator unit 32 has a downstream outlet maple syrup solution spout 34 with a valve controller 36 that controls a valve 33 enabling selective flow of liquid through spout 34. Maple syrup solution flows out from spout 34 via outlet fluid line 51 and is collected in a draw-off tank 38. From draw-off tank 38, the maple syrup solution is further conveyed via an outlet fluid line 124 into a maple syrup press filter unit 40. A circulatory fluid pump 120 is mounted to the rigid frame 122 of the filter press unit 40. Fluid pump 120 forcibly biases maple syrup solution from draw-off tank 38 to filter unit 40 via fluid line 124. Fluid pump 120 particularly biases the maple syrup solution through filtering membranes 126 mounted to the main frame 122 of filter press unit 40, to clear maple syrup solution from impurities. This clear maple syrup solution is then forcibly biased by fluid pump 120 outwardly from filter press unit 40 into the enclosure 42A of a maple syrup fluid stabilizer tank 42 via outlet fluid line 80. In one embodiment, tank 42 is thermally insulated at its peripheral wall; this is then a continuous process. Finally, the clear purified maple syrup will be barreled from stabilizer tank 42 into maple syrup barrels 44 via outlet fluid line 53; this is then a batch process.

In one embodiment, draw-off tank 38 and/or press filter unit 40 are rollably carried over ground by swivel casters 39, 41, respectively.

Valve controller 36 comprises a thermostat linked to a temperature measuring device 36a for measuring the temperature at the pan 31 of evaporator unit 32. An operator can set a threshold temperature value at valve controller 36, at which the valve 33 will open to allow the syrup to flow out through outlet spout 34 into draw-off tank 38.

Processing plant 30 comprises a Brix controller unit 46 that includes a computer 49 that includes usual components such as for example a processor (e.g. a CPU), a data storage device such as a hard drive, a volatile memory unit such as RAM, I/O ports, a user interface including for example a GUI, a keyboard and a mouse, and suitable software that may be executed by the processor to accomplish required operations as detailed hereinafter. Computer 49 could also be controlled by a distant server, and/or include wired or wireless communication means to allow communication and/or control with other devices including e.g. smartphones or other portable devices or computers.

A refractometer 70 (or other suitable fluid degree Brix monitoring device) is provided for measuring through fluid line 73 the °Bx of sampled syrup, and is operatively connected to computer 49 via operational line 79. A wired (or wireless) transceiver 72 is provided to allow the computer to communicate with other devices in processing plant 30, through operational line 75 with computer 49. Valve controller 36 is also connected to computer 49 by electronic line 48. A maple syrup debit sensor 82 of fluid stabilizer tank 42 is connected to computer 49 via operational control line 50, for informing computer 49 of an incoming debit of maple syrup from filter press 40 into tank 42. Furthermore, brix controller unit 46 is connected to the enclosure of pan 31 of evaporator unit 32 by means of an evaporator sample collecting fluid line 52, preferably in the evaporator pan 31 near the outlet leading into outflow fluid spout 34.

A liquid sample return line 54 further connects controller 46 to draw-off tank 38.

Controller computer 49 is also operatively connected to fluid stabilizer tank 42 by means of a tank fluid line 56 feeding maple syrup solution from tank 42 to a buffer fluid line 47 inside controller unit 46. Computer 49 is connected to buffer fluid line 47 via refractometer 70 and operational lines 73 and 79. A maple syrup solution return fluid line 58 returns maple syrup solution from buffer fluid line 47 into the enclosure 42A of fluid stabilizer tank 42. Fluid lines 56 and 58 and associated buffer fluid line 47 constitute a fluid loop for repeat degree Brix monitoring of sucrose concentration in maple syrup. Finally, buffer fluid line 47 of brix controller unit 46 is connected to a fresh water feed source 60 by means of a water fluid line 62.

In one embodiment, fluid stabilizer tank 42 includes a thermally insulating liner 43A against the peripheral wall 43, the flooring 43B and the cover 96 thereof. Inside the enclosure 42A of fluid stabilizer tank 42, a mechanical mixer 90 is provided comprising an elongated vertical axle 92 rotatably carried by a top end motor 94 on the cover 96 of tank 42. Axle 92 drives at its bottom end fluid mixing blades 98. Mixer 90 enhances homogeneity in the temperature and density parameters of the maple syrup inside tank 42, to optimize Brix measurement values. Tank 42 may be rollably carried over ground by swivel casters 100.

Evaporator heater 29 is also operatively connected to computer unit 49 through operational line 110.

Concentric arcuate arrows 102 suggest that maple syrup flow from tank 42 through outlet fluid lines 56 and 47, and return along fluid flow lines 58, in a repeated sequence, to provide optimal Brix concentration measurements of the maple syrup, correlated with the Brix measurements made at draw-off controller 36 thanks to computer unit 49 as detailed hereinafter.

In use, the operator first sets at computer 49 an initial threshold temperature value at valve controller 36 through the degree brix controller 46 interface at computer 49. This can be set at a desired value that a person skilled in the art will intuitively know, e.g. at 1040 Celsius. Alternately, the present invention allows the syrup to be automatically sampled at evaporator pan 31 either in a continuous fashion or at predetermined discrete time intervals through the evaporator sample collecting fluid line 52, and an initial threshold °Bx value can be set at computer 49. Generally, any parameter that is related to the °Bx can be used, i.e. a parameter that allows to determine the °Bx, including a measured °Bx itself.

Then, the temperature will rise in evaporator 32 the selected threshold parameter is reached, i.e. temperature or °Bx. Once that value is reached, computer 49 controls valve controller 36 to open valve 33 to allow the maple syrup to flow out of evaporator 30.

While the measured °Bx at evaporator unit 32 is useful to obtain the appropriate °Bx of the final product, it will likely differ from the °Bx of the final product itself (located in tank 42), so the information obtained by measuring samples at evaporator unit 32 is useful to achieve the ultimate °Bx in maple syrup stabilizer tank 42, but may not—and usually will not—necessarily correspond to the targeted °Bx desired at tank 42. Indeed, the °Bx may vary slightly through the fluid lines, draw-off tank 38 and filter press 40 that separate evaporator 32 from tank 42.

When the threshold temperature at valve controller 36 is reached, or when the desired °Bx measured at evaporator pan 31 is reached, valve controller 36 allows the maple syrup solution to flow out into draw-off tank 38 through fluid line 51 from where it will continuously flow through filter press 40 into tank 42. Any samples taken from evaporator pan 31 are also fed into draw-off tank 38 via fluid return line 54.

As maple syrup solution builds up inside the enclosure 42A of tank 42, samplings are automatically performed through tank sample collecting lines 56, 47 and 58, either in continuous fashion or at discrete time intervals. The °Bx of the measured samples (corrected according to their temperature) allows the brix controller computer 49 to react to automatically correct the °Bx in tank 42:
1) If the °Bx is too low, i.e. if it is below a determined °Bx threshold value, brix controller computer 49 will increase the threshold temperature value at valve controller 36, and/or will increase the threshold heater output at heater 29. This will increase the level of evaporation within evaporator 32; or
2) Inversely, if the °Bx is too high, i.e. if it is above a determined °Bx threshold value, brix controller computer 49 can act in two ways to decrease the level of evaporation within evaporator 32:
   a. It can decrease the threshold temperature value at valve controller 36, and/or decrease the heater output at 29; and/or
   b. It can control the diluting injection of fresh water from fresh water source 60, e.g. from a municipal aqueduct or from any other source such as a water reservoir (not shown), through fresh water feed line 62 and then through buffer fluid line 47 and looping feed lines 56 and 58 about fluid concentration stabilizer tank 42. Any samples collected from tank 42 can be returned to tank 42 through tank return fluid line 58; and water can additionally fed to tank 42 to dilute a solution having a too high °Bx through return fluid line 58.

In one embodiment, either one of an upper threshold or a lower threshold °Bx values are monitored. In another embodiment, both an upper threshold or a lower threshold °Bx values are monitored, defining a range of °Bx values.

In one embodiment, computer 49 may correlate the °Bx measured at tank 42 with the °Bx measured at evaporator pan 31 to adjust the threshold temperature value at valve controller 36. More particularly, depending on the deviation of the °Bx in tank 42 relative to the target °Bx value, and taking into account the current °Bx in evaporator pan 31, the computer could adjust the threshold temperature value at valve controller 36 and/or could control heater 29, in both cases acting to increase or decrease the level of evaporation of the aqueous solution in evaporator 32 to compensate from the over or under concentrated solution in tank 42. This correlation between the °Bx in tank 42 and in evaporator 32 may include for example the following:
If a direct correlation of the °Bx at both tank 42 and evaporator 32 can be made, for example, if they are the same, or if X°Bx at the evaporator is known to correspond to (X−2) °Bx at tank 42, then the reading at evaporator 32 can be relied upon to allow outflow through valve 33 when the (target_°Bx_at_tank_42+2) value is measured at evaporator 32. Any variation of the °Bx at evaporator 32 can immediately lead to a modification of the evaporation level at evaporator 32, and is likely to yield a correct °Bx value at tank 42;
If there are variations of the °Bx in tank 42, and corresponding adjustments need to be made to the level of evaporation in evaporator 32, variations of the °Bx at evaporator 32 can be used to adjust the °Bx at tank 42 without having to wait for the °Bx in tank 42 to change. For example, if the debit rate of the flow of aqueous solution through outlet 34 is monitored, and by keeping track of the time at which aqueous solution flows through outlet 34 (including if the debit rate is variable), the volume of aqueous solution being fed to tank 42 can be known at any given time. Sensor 82 can be used for tracking the debit into tank 42 for computer 49 to know the volume in tank 42 at all times. And/or, the volume of aqueous solution could alternately be directly monitored inside tank 42 with a volume sensor (not shown). By knowing that a known volume or debit of aqueous solution is injected at a known °Bx level from evaporator 32 (including adjusting the calculation if °Bx variations have been monitored between the evaporator 32 and the tank 42), and by knowing the °Bx and volume of the aqueous solution already present in tank 42, then the °Bx at evaporator 32 can be adjusted more precisely to yield a target °Bx at tank 42 that will include previously fed maple syrup and newly fed maple syrup.
More complex mathematical operations can also be accomplished, including using second degree formulas and calculating the slope of the curve of the °Bx variations at the tank 42 and evaporator 32 to correspondingly accelerate or decrease the variation rate of °Bx at evaporator 32 in view of the variation of °Bx at tank 42.

There results a maple syrup processing plant and method of operation thereof allowing for the °Bx to be adjusted by the automatic collection of syrup samples first upstream at the syrup production at evaporator pan unit 32, and second downstream at the final destination at maple syrup solution stabilizer tank 42, which allows to automatically obtain appropriate pre-programmed maple syrup concentration measurements.

The monitoring of the maple syrup parameters both at evaporator 32 and at tank 42, and the adjustment of the valve 33 opening/closure and/or the increase or decrease of heater 29, can be done either in real-time, or at discrete time increments.

Ultimately, the maple syrup solution will be evaporated from maple sap to maple syrup until a °Bx between 65.8% and 69% at 20° C. is achieved; and preferably between 66% and 67%, and even more preferably as close to 66% as possible. This sucrose content in the maple syrup is important, not only for the taste of the product, but also for product conservation of the maple syrup: below a °Bx of 65.8%, the maple syrup can be difficult to conserve and it might spoil and become inedible. Beyond 69%, the maple syrup becomes too concentrated such that the producer will waste money from excess concentration: the reseller that receives barrels of syrup at a degree brix above 69% is likely to dilute it with water to gain volume and sell more product at better profit margin on their end. This would represent a net loss for the maple syrup producer that could have evaporated the syrup to a lesser °Bx value at the outset. Inversely, any maple syrup end product at a °Bx below 65.8% will need to be further evaporated to increase the °Bx to above 65.8%. This will represent a net loss to the reseller. So a relatively precise °Bx of the syrup is required and preferred, both for financial and product conservation reasons.

It can now be understood that with the prior art systems, there is an inertia in a maple syrup evaporator system in that when adjusting the evaporator unit valve controller 36 to increase or decrease the valve threshold temperature value, and/or the evaporator pan heater output at 29, there will be a delay before this has an impact in the change of concentration of the actual °Bx in the insulated tank 42. This can be mitigated in the present invention by having brix controller computer 49 making continuous or closely spaced regular discrete measurements and corresponding adjustments in the valve threshold temperature value and/or the heating output at heater 29 and in fresh water input at fresh water feed 60. Also, by correlating at computer 49 the punctual and/or evolutive (i.e. the rate of change) value of the °Bx in tank 42 vs. the punctual and/or evolutive value of the °Bx in evaporator 32, it is possible to further adjust the valve threshold temperature value and/or the heating output at heater 29 to obtain the desired °Bx at tank 42. For example, if a °Bx at tank 42 remains too low, but the °Bx at evaporator 32 increases, it can be anticipated by computer 49 that the °Bx at tank 42 is likely to rise, so the valve controller 36 and/or heater 29 can be controlled to a lesser impact on the evaporation such that the inertia in the system is considered.

The injection of fresh water at 60 can be taken advantage of by e.g. targeting an output °Bx at evaporator outlet spout 34 that is a bit too high, and by then injecting fresh water through buffer fluid line 47 into fluid stabilizer tank 42 via feed line 58. This is made possible by the dual readings of brix controller computer 49 at evaporator unit 32 and at fluid stabilizer tank 42, being correlated by the computer 49 of controller unit 46.

The present maple syrup processing plant and method of operation thereof makes adjusting the °Bx in the syrup much more reactive, and achieving the desired °Bx with precision and efficiency with little or no intervention by an operator.

I claim:

1. A method of automatically controlling the degree Brix of an aqueous solution at a processing plant outlet of a processing plant of the type comprising:
an evaporator comprising a heater for bringing the aqueous solution inside the evaporator at a temperature higher than the boiling point of the aqueous solution such that its degree Brix will increase during evaporation;
an evaporator outlet for allowing aqueous solution flow out of the evaporator;
an evaporator outlet valve at the evaporator outlet for controlling the flow of the aqueous solution through the evaporator outlet;
a valve controller that controls the evaporator outlet valve; and
a computer linked to at least one of said heater and said valve controller;
with the processing plant outlet being located downstream of the evaporator outlet, the method comprising the following steps:
a. setting a threshold value of a first parameter of the aqueous solution at least one of said computer and said valve controller, the first parameter being related to the degree Brix of the solution;
b. monitoring the first parameter of the aqueous solution within the evaporator with a first parameter sensor, and sending monitored first parameter values to the at least one of said computer and said valve controller;
c. when a monitored value of the first parameter becomes at least equal to said threshold value of said first parameter of the aqueous solution, controlling the valve controller to allow aqueous solution to flow out of the evaporator towards the processing plant outlet;
d. setting a first threshold value of a second parameter of the aqueous solution at said computer, the second parameter being related to the degree Brix of the solution;
e. monitoring the second parameter of the aqueous solution at the processing plant outlet with a second parameter sensor, and sending monitored second parameter values to the computer;
f. when a monitored value of the second parameter becomes at least equal to said first threshold value of said second parameter of the aqueous solution, said computer sending a command to at least one of said heater and said valve controller to adjust the level of evaporation of the aqueous solution.

2. A method of automatically controlling the degree Brix of an aqueous solution as defined in claim 1, wherein said computer is linked to said evaporator heater, said method comprising the step of said computer sending a command to at least one of said evaporator heater and said valve controller to adjust the level of evaporation of the aqueous solution in step (f).

3. A method of automatically controlling the degree Brix of an aqueous solution as defined in claim 2, further comprising the steps of:
g. monitoring a third parameter of the aqueous solution within the evaporator with a third parameter sensor, and sending monitored third parameter values to the computer, the third parameter being related to the degree Brix of the solution;
h. correlating, at said computer, at least one of the first and third monitored parameter values with the monitored second parameter values, to generate an estimated degree Brix at said processing plant outlet, wherein the step of said computer sending a command to at least one of said evaporator and said valve controller to adjust the level of evaporation of the aqueous solution comprising adjusting the level of evaporation with respect to the estimate degree Brix to obtain a target degree Brix of said aqueous solution at said processing plant outlet.

4. A method of automatically controlling the degree Brix of an aqueous solution as defined in claim 3, wherein the step of sending a command from the computer to at least one of said valve controller and said evaporator to adjust the evaporation level of the aqueous solution within the evaporator in step (f) comprises at least one of controlling the valve controller to open or close the evaporator outlet valve, and controlling the evaporator heater to increase or decrease the heat dispensed by the evaporator to the aqueous solution therein.

5. A method of automatically controlling the degree Brix of an aqueous solution as defined in claim 4, wherein the first parameter is the temperature of the aqueous solution in the evaporator.

6. A method of automatically controlling the degree Brix of an aqueous solution as defined in claim 5, wherein the second parameter is the degree Brix of the aqueous solution at the processing plant outlet.

7. A method of automatically controlling the degree Brix of an aqueous solution as defined in claim 6, wherein the third parameter is the degree Brix of the aqueous solution in the evaporator.

8. A method of automatically controlling the degree Brix of an aqueous solution as defined in claim 1, wherein step (e) is accomplished in real time.

9. A method of automatically controlling the degree Brix of an aqueous solution as defined in claim 7, wherein steps (e), (g) and (h) are accomplished in real time.

10. A method of automatically controlling the degree Brix of an aqueous solution as defined in claim 1, wherein step (e) is accomplished at discrete time intervals.

11. A method of automatically controlling the degree Brix of an aqueous solution as defined in claim 10, wherein steps (e), (g) and (h) are accomplished at discrete time intervals.

12. A method of automatically controlling the degree Brix of an aqueous solution as defined in claim 1, wherein said processing plant outlet is located within a tank and said processing plant comprising a water source, a water outlet allowing water to flow from said water source into said tank, a water outlet valve for controlling the flow of water through the water outlet, and a water outlet valve controller linked to said computer and that controls the water outlet valve, and wherein in step (f) when a monitored value of the second parameter becomes at least equal to said second threshold value of said second parameter of the aqueous solution, said computer sending a command to said water outlet valve controller to inject water in said tank to adjust the °Bx of the aqueous solution.

13. A method of automatically controlling the degree Brix of an aqueous solution as defined in claim 1, wherein said processing plant further comprises a filtering unit between said evaporator outlet and said processing plant outlet, with the aqueous solution flowing from evaporator outlet to said processing plant outlet flowing through said filtering unit.

14. A method of automatically controlling the degree Brix of an aqueous solution as defined in claim 7, wherein said monitoring of the degree Brix at said processing plant outlet and at said evaporator is performed by means of a selected one of a hydrotherm and a refractometer.

15. A method of automatically controlling the degree Brix of an aqueous solution as defined in claim 7, further comprising the following steps:
i. setting a second threshold value of said second parameter of the aqueous solution at said computer, such that the first and second threshold values define a range of values of said second parameter of the aqueous solution;
j. at step (f), when a monitored value of the second parameter is outside said range of values of said second parameter of the aqueous solution, said computer sending a command to said valve controller to adjust the level of evaporation of the aqueous solution.

16. A method of automatically controlling the degree Brix of an aqueous solution as defined in claim 15, wherein said range of values of said second parameter of said aqueous solution is a degree Brix range between 66° and 67°.

17. A processing plant for an aqueous solution comprising:
an evaporator comprising:
a heater for bringing the aqueous solution inside the evaporator at a temperature higher than the boiling point of the aqueous solution such that its degree Brix will increase during evaporation;
an evaporator outlet for allowing aqueous solution flow out of the evaporator;
an evaporator outlet valve at the evaporator outlet for controlling the flow of the aqueous solution through the evaporator outlet;
a valve controller that controls the evaporator outlet valve;
a computer linked to at least one of said heater and said valve controller; and
a processing plant outlet being downstream of the evaporator outlet;
wherein the computer comprises a computer readable medium storing a computer program that, when executed by a processor of the computer, allows the following:
a. setting a threshold value of a first parameter of the aqueous solution at at least one of said computer and said valve controller, the first parameter being related to the degree Brix of the solution;
b. monitoring the first parameter of the aqueous solution within the evaporator with a first parameter sensor, and sending monitored first parameter values to the at least one of said computer and said valve controller;
c. when a monitored value of the first parameter becomes at least equal to said threshold value of said first parameter of the aqueous solution, controlling the valve controller to allow aqueous solution to flow out of the evaporator towards the processing plant outlet;
d. setting a first threshold value of a second parameter of the aqueous solution at said computer, the second parameter being related to the degree Brix of the solution;
e. monitoring the second parameter of the aqueous solution at the processing plant outlet with a second parameter sensor, and sending monitored second parameter values to the computer;
f. when a monitored value of the second parameter becomes at least equal to said first threshold value of said second parameter of the aqueous solution, said computer sending a command to said at least one of said heater and said valve controller to adjust the level of evaporation of the aqueous solution.

18. A processing plant for an aqueous solution as defined in claim 17, wherein said processing plant outlet is located within a tank, said processing plant further comprising a water source, a water outlet allowing water to flow from said water source into said tank, a water outlet valve for controlling the flow of water through the water outlet, and a water outlet valve controller linked to said computer and that controls the water outlet valve, and wherein when a monitored value of the second parameter becomes at least equal to said second threshold value of said second parameter of the aqueous solution, said computer sending a command to said water outlet valve controller to inject water in said tank to adjust the °Bx of the aqueous solution.

19. A processing plant for an aqueous solution as defined in claim 17, further comprises a filtering unit between said evaporator outlet and said processing plant outlet, with the aqueous solution flowing from said evaporator outlet to said processing plant outlet flowing through said filtering unit.

20. A processing plant for an aqueous solution as defined in claim 17, wherein said second parameter is the degree Brix, said processing plant comprising a selected one of a hydrotherm and a refractometer to measure the degree Brix at said processing plant outlet.
